(19) United States
(12) Patent Application Publication
(10) Pub. No.: US 2017/0132715 A1
(43) Pub. Date: May 11, 2017

(54) TIMELINE RECONSTRUCTION

(71) Applicant: MSFS, LLC, Houston, TX (US)

(72) Inventors: Regina K. GOROG, Houston, TX (US); Elliott C. GOROG, Houston, TX (US); Garland LEVIT, Houston, TX (US); Donald N. LEVIT, Houston, TX (US)

(73) Assignee: MSFS, LLC, Houston, TX (US)

(21) Appl. No.: 14/933,836

(22) Filed: Nov. 5, 2015

(51) Int. Cl. G06Q 40/00; G06F 17/30

(52) U.S. Cl. CPC G06Q 40/12; G06F 17/30551

(57) ABSTRACT

An electronic timeline is established to include items to be completed. A projected set of variables is matched to the items to be completed. The variables are also matched with a corresponding mark showing total progress along the electronic timeline. In a new period, the mark showing total progress prior to the new period is compared against the electronic timeline. When a predetermined event occurs, the variable to apply for the new period is identified by matching the mark showing total progress prior to receipt of confirmation of completion of the new item with two closest marks showing total progress on the electronic timeline, and by calculating an interpolated variable from two variables from the projected set of variables that correspond to the two closest marks showing total progress. The interpolated variable is applied for the period to generate a new cumulative score showing total progress for the account.

### BACKGROUND

1. Field of the Disclosure

The present disclosure relates to the field of electronic (computerized, digital) timelines. More particularly, the present disclosure relates to reconstructing electronic timelines.

2. Background Information

Account service providers may identify accounts and account holders by, for example, addresses such as email addresses or telephone numbers, names such as first and last name, and/or identification numbers such as account numbers or social security numbers. However, at times an account service provider may receive information on behalf of an account that does not identify the account or account holder. This might occur, for example, when information is received from an intermediary on behalf of the account holder, and the intermediary does not provide information specific to the account holder. An example might be when an intermediary only knows, for example, a group account number for a group that includes the specific account for an account holder.

Additionally, some types of accounts have fixed plans of expected activity until the activity for the account is completed. However, if events such as delays or early progress in completing an expected activity occur, an account service provider may not have a way to reconstruct the account plan. A service provider may need to reconstruct an account plan to, for example, identify progress for the account at the present time relative to the expected progress in the original plan for the present time, and/or re-compute the account plan when additional time or less time is needed to complete the activity for the account. Examples of the kinds of accounts contemplated herein include accounts provided by account service providers for construction activity, weight loss activity, payment activity, and so on.

Account information is even more difficult to complete if, for example, an account plan uses a variable that can vary each period, such that projected variations can change. This may be true in circumstances where a relatively fixed plan has a variable that varies over time (i.e., for each period), and the variable deviates from an expected pattern based on the occurrence of a one-time event. Complications can result in complexity from the account service provider's viewpoint, in that, for example, the account plan may be altered based on the deviation from expectations. The account provider may be challenged to identify the relative progress for an account, particularly upon the occurrence of one-time events that change the account plan. The account provider may also be challenged to determine which variable or constant to use when a pattern of preplanned variations deviates, such as based on the occurrence of the one-time events.

### BRIEF DESCRIPTION OF THE DRAWINGS

FIG. 1 illustrates an exemplary computer system used to provide timeline reconstruction, according to an aspect of the present disclosure;

FIG. 2 illustrates an exemplary network system used to provide timeline reconstruction, according to an aspect of the present disclosure.

FIG. 3 illustrates a table showing exemplary inputs and factors for determining an electronic timeline for an account provider in timeline reconstruction, according to another aspect of the present disclosure.

FIG. 4 illustrates a flowchart showing an exemplary method for providing timeline reconstruction, according to an aspect of the present disclosure.

FIG. 5 illustrates a flowchart showing an exemplary method for completing account information, according to an aspect of the present disclosure.

FIGS. 6A and 6B illustrate an electronic timeline, according to an aspect of the present disclosure.

FIGS. 7A and 7B illustrate an electronic timeline, according to an aspect of the present disclosure.

FIGS. 8A and 8B illustrate an electronic timeline, according to an aspect of the present disclosure.

FIG. 9A and 9B illustrate an electronic timeline, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Account timelines as described herein are electronic timelines generated by a service provider to track account activity and service provider expectations. As such, the electronic timelines are not necessarily provided to the customers, and may when appropriate be generated and used exclusively in internal computer systems of the service provider. All electronic timelines described herein are computerized and automated, such that an electronic timeline can be initially constructed and later reconstructed when information necessary to reconstruct the electronic timeline is obtained.

As described herein, an electronic timeline may include variations that are projected in advance with the assumption that a particular event does not happen one or more times. The particular event may be a one-time addition to or subtraction from an account balance, such that the electronic timeline projection has to be redone upon the occurrence of the one-time event. The particular event may be a one-time delay for or early completion of an account objective, such as a construction delay or early progress.

Additionally, electronic timelines may be visualized on a graphical user interface in 2 or more dimensions. Electronic timelines may also be stored as data in a computer readable medium, and generated and updated by a computer processor.

The electronic timeline may include timeline markers. For example, a timeline marker may be a mark indicating timing information such as marks at 30 day or monthly increments. Alternatively, a timeline marker may be a mark indicating projected completion information such as:
sequential construction requirements to complete a construction project
geographic information such as different locations to be completed under a construction contract
amounts of weight to be lost under a weight loss plan
monthly payment due dates for payments expected until a balance is paid in full

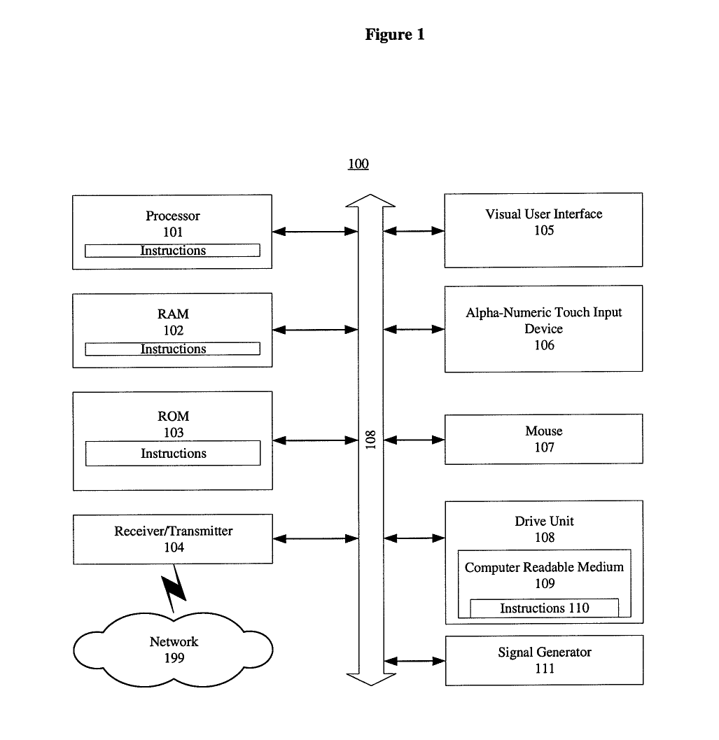

FIG. 1 illustrates exemplary computer system 100 used to provide timeline reconstruction, according to an aspect of the present disclosure. The computer system 100 can include a set of instructions that can be executed to cause the computer system 100 to perform methods and functions disclosed herein. The computer system 100 may operate as a standalone device or may be connected, for example, using a network 199, to other computer systems or peripheral devices.

The computer system may operate in the capacity of a server computer or as a client computer in a server-client network environment, or as a peer computer system in a peer-to-peer (or distributed) network environment. The computer system 100 can also be implemented as or incorporated into various devices, such as a personal computer (PC), a laptop computer, a server computer, a client computer, a tablet computer (PC), a personal digital assistant (PDA), a mobile device, a smart phone, or any other machine capable of executing a set of instructions (sequential or otherwise) that specify actions to be taken by that machine. In a particular embodiment, the computer system 100 can be implemented using electronic devices that provide voice, video or data communication.

Further, while a single computer system 100 is illustrated, the term “system” shall also be taken to include any collection of systems or sub-systems that individually or jointly execute a set, or multiple sets, of instructions to perform one or more computer functions as described herein. Methods as described herein may be performed wholly or in part by or using one or more applications installed on and even downloaded to networked device with a processor and memory as described herein.

As illustrated in FIG. 1, the computer system 100 may include a processor 101, for example, a central processing unit (CPU), a graphics processing unit (GPU), or both. Moreover, the computer system 100 can include a random access memory (RAM) 102 and a read only memory (ROM) 103 that can communicate with each other via a bus 108. As shown, the computer system 100 may further include a visual user interface 105 that shows still or moving images, such as a liquid crystal display (LCD), an organic light emitting diode (OLED), a flat panel display, a solid state display, or a cathode ray tube (CRT). Additionally, the computer system 100 may include an alpha-numeric touch input device 106, such as a keyboard/virtual keyboard or touch-sensitive input screen, and a mouse 107. The computer system 100 can also include a drive unit 108, a signal generator 111, such as a speaker or remote control, and a receiver/transmitter 104.

In a particular embodiment, as depicted in FIG. 1, the drive unit 108 may include a computer-readable medium 109 in which one or more sets of instructions 110, e.g. software, can be embedded. A computer-readable medium 109 is a tangible article of manufacture, from which sets of instructions 110 can be read. Further, the instructions 110 may embody one or more of the methods or logic as described herein. In a particular embodiment, the instructions 110 may reside completely, or at least partially, within the random access memory 102, the read only memory 103, and/or within the processor 101 during execution by the computer system 100. The random access memory 102, the read only memory 103, and the processor 101 also may be or may include computer-readable media that are tangible and non-transitory during the time instructions 110 are stored therein.

The system 100 shown, described and envisioned in one or more devices in various embodiments can broadly include a variety of electronic and computer systems. In accordance with various embodiments of the present disclosure, the methods described herein may be implemented by software programs executable by a computer system. The software programs include executable instructions executed by processors as described herein. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 109 that includes instructions 110 or receives and executes instructions 110 responsive to a propagated signal so that a device connected to a network 199 can communicate voice, video or data over the network 199. Further, the instructions 110 may be transmitted or received over the network 199 via the receiver/transmitter 104. The computer-readable medium 109 or any other computer-readable medium contemplated herein may be a tangible machine or article of manufacture that is tangible and non-transitory for a period of time during which instructions and/or data are stored therein or thereon.

As described herein, an electronic timeline for an account is mapped based on expected goals to be met, such as amounts of weight to be lost, construction tasks to be completed, periodic payments to be made, and so on. An electronic timeline is computerized and digital, and may be stored on a computer readable medium generated, by a computer program executed by a computer processor, and displayed visually on an electronic computer display. The electronic timeline for an account may reflect an original set of variables that can vary based on the progress for the account. Examples of variables that can be applied to account data using an electronic timeline include acceleration rewards for on-time or early achievements, variable multipliers to be applied to periodic payments or account balances over time, deceleration expectations for weight loss over time (i.e., to reflect the increased difficulty of losing weight after a weight loss process has achieved initial goals) and so on. The variables may vary as a form of “reward” for conduct such as on-time or early completions of goals, incentives for any desirable conduct such as agreeing to electronic communications (rather than mail), or in the case of an reimbursement account, the lack of claims being filed against the reimbursement account.

The electronic timeline for an account and map may ultimately show projected progress for each time period. For example, for an auto payment a borrower may agree to make periodic payments for 60 months, so the progress may be shown either as the amount due (decreasing from the start) or the amount of the original loan that has been paid (increasing from the start). For a construction contract, an electronic timeline and map may show a set of construction items and when each is to be completed, or when construction at different locations under the contract is to begin.

The electronic timeline for an account as described herein is a full schedule, such as a schedule that includes a string of expected goals or objectives to be completed from start until finish. The account for which the electronic timeline is produced may be an account for any form of product or service that can be shown on an electronic timeline. The disclosure contained herein is not directed to how to complete a transaction between a debtor and lender, but is instead a description of, for example, how a service provider can reconstruct an electronic timeline on-the-fly, such as when variations from an original electronic timeline occur.

In embodiments, goals expected to be met on an electronic timeline for an account might be fixed, and a variable multiplier may be applied to all or part of a value corresponding to the goal. In this way, one or more expected periodic progress markers used to create a cumulative score for an account can be varied by period by applying the variable multiplier value each period. When a cumulative score that should be increasing over time decreases based on a one-time factor, the timeline can be reconfigured to account for the one-time factor using the methodologies taught herein. The same methodologies can be used also for cumulative scores that decrease over time when such cumulative scores increase based on a one-time factor. Additionally, the methodologies taught herein can be used to reconstruct an electronic timeline in circumstances such as for accounts that include a periodic, fixed numerical value that is multiplied by a variable that changes in different periods.

As noted already, the same methodology can be used to recreate electronic timelines for construction projects, weight loss programs, and other areas where expectations are set down over time in advance, including workplace and educational projects.

A full schedule of the expected account timeline can be generated or regenerated on-demand and/or in real time using mechanisms taught herein. In the event of variable multipliers, the expected schedule can be set up using the expected changes in the variable multiplier in the original timeline, so that a different multiplier is projected forward for different periods. The projected account timeline (map) can consider how much progress is expected each period, and what the aggregated cumulative score should be for the period considering the expected input and the various expected multipliers.

The original map could appear as a step function as follows:

The goals to be met (such as expected progress) can be used to set minimum and maximum values or other parameters for each period to show where the present location is on the electronic timeline. In this sense, if 20 of 60 expected goals are met for an account, the calendared accounts location and progress completion rate (e.g., balance or other cumulative score) on the electronic timeline would be 20 units forward of the origin on the X-axis. However, if a one-time step backward (such as a reduction in balance or other cumulative score) occurs, the timeline for the calendared account may be set back a number of units. The “actual” balance or other current account score after the reduction can be compared to the original expectations on the original account timeline in order to identify the two closest pre-set goals on the original account timeline. An interpolation between those two closest pre-set goals from the original timeline can be used to calculate a ratio (percentage). The resultant ratio (percentage) can then be applied to the difference between the variables on the original timeline that correspond to the two closest pre-set goals. A new value for the variable for the current location of the account and most recent accomplished step can then be identified. In this way, the electronic timeline can be rebuilt to account for even one-time offsets to the original expectations for the account.

In the electronic timeline shown above, the incremental values of the Y-axis may correspond to an expected incoming fixed payment so that each step is the same height. The Y values can be multiplier coefficients that are applied to the incoming amount each period. The X values can be the requisite balances after a multiplier coefficient is applied to an incoming amount and the amounts are aggregated.

As described above, linear interpolation can be used to identify a value between two multipliers that should be used for an incoming amount, and the new value can be used as the variable multiplier for an incoming amount. Once the correct new variable multiplier is found, it can be used as a coefficient applied to an incoming amount and the result can be credited to an account. Of course, interpolation may be non-linear too, such as by taking an average of the two closest multipliers. Similarly, interpolation may use additional multipliers such as the four closest, or different multipliers such as the third and fourth closest but not the first and second closest.

As described above the interpolation between values on the timeline can be applied to identify an appropriate variable value for the identified current location on the timeline using a set of predetermined rules. For example, if an account that is supposed to be at the 32nd (thirty second) month is instead at the 30½ month, a variable value may be reset to 0 (zero) because the account is behind schedule. Alternatively, the variable might be held at the value used at the 30th (thirtieth) month since the 30th month is the last location on the original timeline. The variable might also be linearly or non-linearly interpolated between variable values for the 30th (thirtieth) and 31st (thirty first) months in the manner as described above for interpolation to identify the timeline location.

The mechanisms described herein include ways to generate and re-generate an electronic timeline for even complicated accounts, even when a projection of variables for the timeline deviates based on the occurrence of a one-time event. As an example of an account to which the disclosure herein can be applied, a reimbursement account can be built with a periodic contribution amount. A periodic multiplier contribution can be derived from the periodic contribution amount. The periodic multiplier contribution is an aggregated balance. The periodic multiplier contribution is derived from the periodic contribution amount and added to a cumulative multiplier contribution balance. These balances combined can be provided as reimbursement benefits akin to a savings deposit account with interest accumulated at a rate that varies each period and that is applied to each periodic deposit using instructions executed by a computer. Even with such complex variations, a timeline can be reconstructed using the mechanisms described herein.

As another example of an account to which the disclosure herein can be applied, a client of a weight loss clinic can use the timeline reconstruction process as described herein when the client falls behind on a program due to a setback. In this way, the timeline can be built with non-linear expectations for weight losses, such as an expectation that the client will lose 5 pounds in the first 30 days, 4.4 pounds in the next 30 days, 4.1 pounds in the next thirty days and so on. The “markers” on the timeline can be marked both with the expected losses for the period, and with the total weight expected for the period. Thus, the total expected weight at a point in time can be considered analogous to an expected balance for a financial account.

For the weight loss program example, the present disclosure can be used when the client contacts the program provider and does not have the information of the original full timeline. The program provider can reference the original timeline and ask the client to provide their present weight in order to identify where on the original timeline the client is. The program provider can also use the most recent weight loss reported by the client (i.e., before the setback) to identify where on the original timeline the client's progress should be. The most recent weight loss can be compared to the closest points on the original timeline to find where the client is on the original timeline.

To be clear, the reconstruction of a timeline as described herein is performed using an automated program executed by a computer, using inputs provided from the client and/or from client records. As such, a timeline may indicate that a client initially weighed 195 pounds, was on a 90 day program, and was expected to end the program with a weight of 175 pounds. The variable used for the timeline may be that the expected incremental weight to be lost in each equal portion of the timeline (e.g., 5 days) is expected to get smaller and smaller, such as by the same amount or by a percentage of the previous amount or the original amount. The computer can take the inputs including the current value of either the user's weight/balance, and/or the most recent weight change for the most recent period, and then not only reconstruct the timeline but also provide information to the client as to where the client is on the original timeline. This information can be used to show how much remains on the timeline for the client to complete. In the example of a construction timeline, a delay from original expectations can be correlated with a penalty imposed on the contractor or general contractor overseeing or performing the construction (or otherwise assumed responsible for the delay).

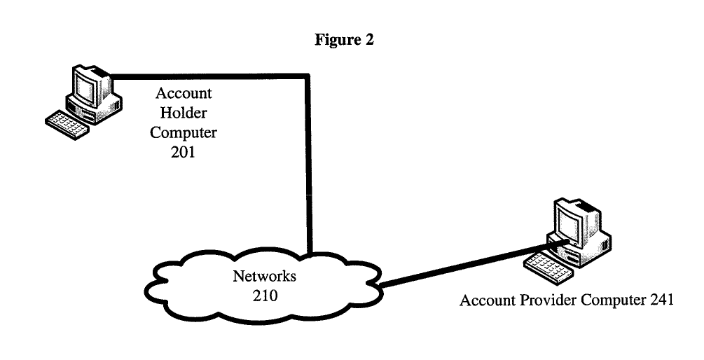

FIG. 2 illustrates an exemplary network system used to provide timeline reconstruction, according to an aspect of the present disclosure. In FIG. 2, an account holder computer 201 communicates over networks 210 with account provider computer 241. The account holder computer 201 and account provider computer 241 are representative of computing and communications devices with a processor and memory. The methods described herein can be performed on, by or for one or more of the computers 201, 241 described herein. The methods described herein may also be performed wholly or in part by server computers or other devices that are not shown, but which can execute logic to implement the methods to provide a reimbursement product to an account holder as described herein. The networks 210 may be one or more of a wireless network and a wired network, one or more of a local area network and a wide area network, and may use any known protocols for wired and wireless communications that are compatible with the methods described herein.

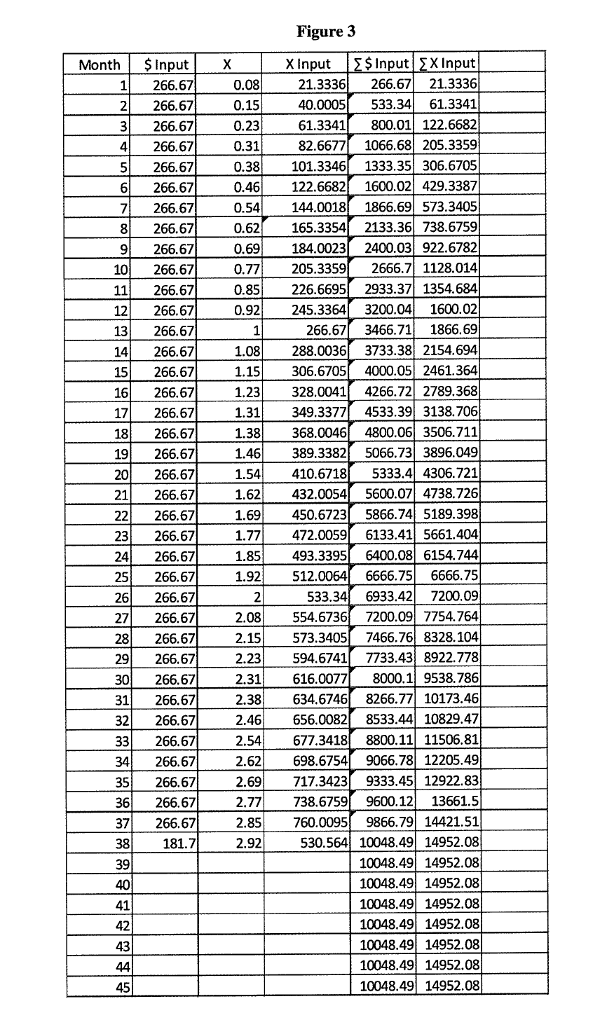

FIG. 3 illustrates a table showing exemplary inputs and factors for determining balances in one of the examples described herein, according to an aspect of the present disclosure. In the embodiment of FIG. 3, the left column shows periods numbered from 1 to 45. The periods shown in FIG. 3 may be months, quarters, weeks, days or any other period consistent with the explanations herein. The second column shows, for periods 1 to 38, contributions submitted by or on behalf of an account holder. The contributions in the second column of FIG. 3 are periodic amounts, though the denominations and currency mediums may vary. The fifth column shows the sum of the periodic amounts for each period up to 45.

In the example of FIG. 3, the amounts correspond to periodic weight loss goals in the weight loss examples, and construction item completions in the construction examples. The balance corresponds to the current weight (or total weight loss) in the weight loss examples, and the overall progress in the construction examples.

In FIG. 3, a variable multiplier (X) that can vary for each period is shown in column 3. In the embodiment of FIG. 3, the variable multiplier (X) increases for each period. As explained herein, the variable multiplier (X) would normally be expected to increase after periods for which no one-time event occurs. The one-time event may be, for example, a claim filed against a reimbursement amount, or another one-time event such as a withdrawal from a certificate of deposit. If the variable multiplier (X) increases, the cumulative multiplier contribution balance calculated using the variable multiplier (X) increases. In this embodiment, if the multiplier (X) is increased and nothing else is changed, the account value will increase. However, the multiplier (X) could still increase for periods following a one-time event, and decrease or stay the same after periods for which no one-time event occurs, as the occurrence of the one-time event may not be the sole factor in determining the value of the variable multiplier (X). The multiplier (X) for each period is multiplied by the periodic contribution amount for each period to obtain a new periodic multiplier contribution for each period as X input in column 4. The sixth column in FIG. 3 shows the cumulative multiplier contribution balance (sum of periodic multiplier contributions) for each period up to 45.

The variable multiplier X in the embodiment of FIG. 3 can correspond to a multiplier applied to an initial weight loss amount in the weight loss examples. For instance, if a client is initially expected to lose 1.5 pounds in the first five days of a timeline, the expectation may be that each incremental period in the timeline will result in a weight loss of only 90% of the previous period, or an incrementally additional 10% reduction from the original 1.5 pounds for each incremental period. Thus, for example, in the weight loss example, a variable might be the amount to be lost for each period such as 1.5, 1.35, 1.20, 1.05 when the amount to be lost changes by the same percentage relative to the initial amount to be lost. Alternatively, the variable may be applied as a percentage reduction compared to the previous, such as by reducing the previous reduction by 10% to result in 1.5, 1.35, 1.215, 1.0935. The variable may also initially be a percentage reduction relative to the original weight of the client, and then an adjustment to the initial variable systematically reduced for each period. In the latter example, the initial variable could be 1% of an initial weight of 150 pounds, so 1.5 pounds, and later values could be calculated the same way as above either by taking 0.15 pounds more off each sequential period or by taking, e.g., 10% off of the value for the initial period.

For the weight loss example provided above, the timelines and expectations may vary also by, for example age, gender, initial weight, health conditions such as body mass index, and so on. In this way, a timeline may vary for each client, and this of course may result in the complexities that are addressed herein by the mechanisms used to reconstruct the timeline when adjustments occur. In this way, a client can be presented with an updated timeline and shown by way of comparison the change in status relative to the original timeline.

As shown in FIG. 3, a periodic contribution is collected for each period. The periodic contribution may be collected as cash, a check, an electronic deposit or payment, a credit card payment, or any other form of payment known. As described herein, the periodic contribution is used to derive a periodic multiplier contribution, which is one of the more complex forms of an account that illustrates the electronic timeline reconstruction described herein. The account for which the electronic timeline in FIG. 3 is constructed may be, for example, a reimbursement account used as reimbursement for claims. However, as noted previously, the disclosure herein is for how to reconstruct a timeline for an account, and is not particular to the calendared account itself such as whether the calendared account is a reimbursement account, a weight loss client's account, or a construction account. Of course, analogous timelines may be used in other circumstances that would benefit from the automated mechanisms taught herein.

For an exemplary “first period” such as period 5 in FIG. 3, $266.67 is collected for a total of $1333.35 collected in periods 1 to 5. The periodic contribution is collected from or on behalf of the account holder, and is aggregated as a balance of periodic amounts to date. As explained herein, however, a balance may also be reduced by the amounts paid as one-time events.

After a one-time event such as a deduction from the account balance, a periodic contribution amount in the next period is multiplied by the multiplier for the next period and added to what remains from the previous periodic multiplier contribution balance to obtain a new periodic multiplier contribution balance. The new periodic multiplier contribution for each period is obtained by multiplying the balance through the period by a multiplier specific to the period as shown in the third column. In FIG. 3, the multiplier is expected typically to increase for each successive period for which a one-time event does not occur.

In the table of FIG. 3, the multiplier (X) may be reduced for a subsequent period after a one-time event. On the other hand, periodic payments are waived at period 39 (and reduced in period 38) once the balance reaches a certain level. The collection of periodic amounts can then be reinstated once the level is reduced, such as by the occurrence of a one-time event.

The new cumulative multiplier contribution balance for a period is obtained by adding the result of multiplying the variable multiplier in the third column for the period with the periodic contribution amount in the second column for the period, with the result of multiplying each multiplier in the third column for previous periods with the periodic amounts in the third column for the previous periods respectively, and subtracting any amounts for goals not met and taken from the cumulative multiplier contribution balances in the period or previous periods. The balance in the firth period is obtained by subtracting any amounts from the calendared account made in the period and previously from the collected periodic amounts from the period and previously.

As shown, the account value normally increases for each successive period for which a one-time event does not occur, and typically continues to increase over time.

An example of an embodiment of timeline reconstruction described herein includes a computerized data set that projects account progress through to the anticipated completion of the account. Account progress may be measured positively, such as by a percent completed, an amount paid, or which of a set of tasks to be competed for the account has been completed. Account progress may also be measured negatively, such as by percent remaining, an amount remaining to be paid, or which of a set of tasks to be completed for the account remains to be completed. When the account is off the original timeline, the account service provider can obtain the current placement of the account holder using information from the account holder such as weight, work completed, an amount (such as a dollar amount) debited from or credited to an account, and so on. The computer system for the account provider initially reconstructs the original timeline using the date the timeline started and was projected to end. The computer system identifies the current location relative to the original timeline, using either information directly received from the account holder, or information of the last marker reached on the timeline in combination with the information directly received from the account holder. The computer system can then compare the current location to the two closest original numerical markers on the timeline, and extrapolate between any affiliated values for the two closest original numerical markers in order to find a comparable affiliated value for the present location.

In the example of the preceding paragraph, each projected timeline marker on the original timeline may include multiple markers, such as a projected weight, balance, percentage complete, and percentage remaining. Each projected timeline marker on the original timeline may also include a variable with a value that, for example, depends on the specific events occurring up to the time the marker is reached. In this way, the value of the variable may depend on the absence of a particular one-time event from happening at each projected timeline marker, so that the variable values can increase, and even increase non-linearly by an increasing amount, at each timeline marker.

At the time each timeline marker is reached, such as end of month, the account provider can reconstruct the original electronic timeline using the computer system. The account provider can then identify whether one-time events have occurred and, if they have, the update the original timeline by interpolation or offset to find the current location. As noted, affiliated variables that vary depending on circumstances up to the current time, can be then calculated such as by resetting to an initial value, by linear interpolation between the two closest projected values for the variable on the original electronic timeline, by adding or subtracting from one of the two closest projected values proportionate, or in other ways predetermined by the account provider.

For example, an electronic timeline for construction may be reconstructed and updated when the account holder is a construction company reporting early progress. Compensation such as a bonus may be provided for when such early progress is made compared to the original timeline. In this way, the bonus may be made variable based on how much progress is made relative to the original electronic timeline, and identifying the exact current location relative to the original timeline can be used as a key to identifying the value to be attributed to the variable for the exact current location. In this way, the new variable value can be identified and applied.

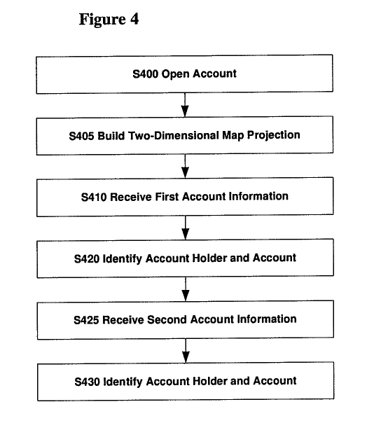

FIG. 4 illustrates a flowchart showing an exemplary method for providing timeline reconstruction, according to an aspect of the present disclosure. In FIG. 4, an account is opened at S400. A two-dimensional map projection of the electronic timeline is built at S405. First account information is received at S410. The first account information can include the periodic amount for the calendared account, the reported weight loss expected for the current period, the next checklist item for a construction list, and so on. The account holder and account are identified at S420. Second account information is received at S425. The second account information may be another periodic amount for the calendared account, another reported weight loss expected for the next period, or the next checklist item completed for a construction list. At S430, the account holder and account are identified.

In the example of FIG. 4, the calendared account may be for an individual who agrees to contribute a fixed amount under the arrangement shown in FIG. 3 or a similar arrangement. The initial periodic contribution of $266.67 per period is determined and used to build the two-dimensional map projection at S405. The variable multiplier may reflect perceived risk factors for one-time items, but the key point here for the variables that complicate account projections is simply that they can vary.

As illustrated, after a one-time item, the multiplier in the third column of FIG. 3 can be lowered to a lower value, but is otherwise generally expected to increase over time for so long as no other one-time items occur.

For example, assume the balance has reached $10,048.49 at period 38, and a one-time deduction from the account balance occurs, such as a $4,000 deduction. The balance decreases by $4,000.00, and the next period a periodic contribution of 266.67 would again be collected in order to begin building the balance back up. However, the multiplier resets lower to 0.08 as in period 1, and the variable X in the fourth column of FIG. 3 will again only increase slowly in this example as the multiplier in the third column of FIG. 3 increases over time from 0.08. Notably, however, even when the variable multiplier is reduced, it does not have to be reduced to a particular predetermined number from a particular earlier period. Rather, as described herein, the electronic timeline can be rebuilt, and the multiplier identified from the original projected balances for the calendared account, so long as the multiplier is correlated specifically with the balance level.

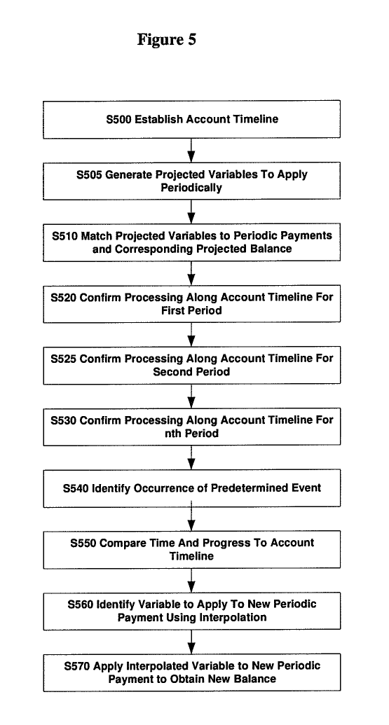

FIG. 5 illustrates a flowchart showing an exemplary method for completing account information, according to an aspect of the present disclosure. At S500, an electronic timeline for an account is established. At S505, a system generates projected variables to apply periodically to incoming values such as fixed periodic amounts. At S510, the projected variables are matched to periodic amounts and corresponding projected balances. At S520, the system confirms proceeding along the projected account timeline for a first period, at S525 the system confirms proceeding along the projected account timeline for a second period, and at S530, the system confirms proceeding along the projected account timeline for the nth (arbitrary number more than 2) period. At S540, the system identifies the occurrence of a predetermined event. At S550, the system compares the progress (current numerical location on the timeline) after the predetermined event to the two closest numerical progress markers on the timeline. At S560, the system identifies a variable to apply to a new fixed periodic amount using interpolation based on the two closest numerical progress markers. At S570, the system applies the new variable identified using interpolation to the new periodic amount to obtain a new numerical location on the timeline, and reconstructs the projected account timeline for future periods taking into account the occurrence of the one-time event by projecting forward from the new numerical location on the timeline.

That is, as described herein, an original account timeline can be rebuilt in multiple dimensions, even when complicating factors such as one-time events and periodic variables are used for the calendared account. Such rebalancing can be used by an account service provider to maintain accurate records and projections, and can be used to provide information to customers to show reconstructed and updated (revised) account timelines even for the most complicated forms of accounts.

Other instances that can lead to a need to reconstruct a timeline or build a new timeline can include changes to the original account projections. For example, a weight loss client may indicate that the weight loss plan it too onerous, and they want a timeline with lower expectations for each period. A construction company may indicate that they need an updated timeline for more (or less) compensation given difficulties being encountered. A timeline may also be extended in length, such as from 30 periods to 60 periods. In the example of payments, a client may wish to make larger payments. Of course, any of these changes could be made in the middle of an original timeline, so that the new timeline will be a hybrid of the previous timeline and the new timeline.

As described herein, current period inputs and/or a current account score (progress report, balance etc.) can be used to reconstruct a timeline in an automated process. The automated process can then generate an updated timeline to show a client where they are relative to an original timeline, and this can include showing the users a “delay” imposed relative to the original timeline. This can be done using specific information for adjustments, such as reports of setbacks or progress relative to an original expectation. The new timeline will incorporate the information of the setbacks or progress (e.g., one-time items), and then include an updated timeline with adjusted expectations and timing compared to the original timeline. In this way, a timeline can be rebuilt and adjusted by identifying where on an original timeline a client is when they are not where they are supposed to be.

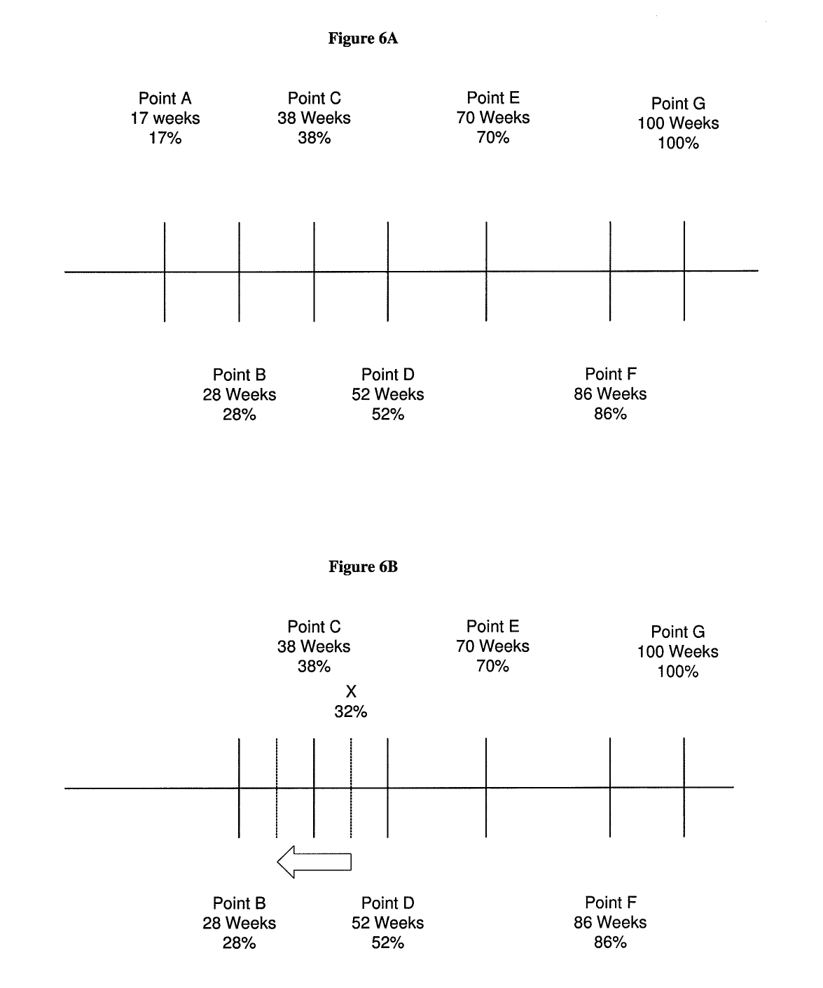

FIGS. 6A and 6B illustrate an electronic timeline, according to an aspect of the present disclosure. In FIG. 6A, an original timeline shows 7 progress markers labeled as points A through G. For ease of understanding, each progress marker corresponds to a percentage of completion that also corresponds to the number of weeks progressed along the timeline. In FIG. 6B, a one-time event occurs and moves progress back as shown by X. The computer system described herein recognizes the one-time event, and extrapolates between points B and C to determine the location of X and the corresponding values such as percentage of completion and weeks of progress. The extrapolation may be performed using data from the account holder, such as current weight, current progress, how much money has been withdrawn against an account from the last report, and so on.

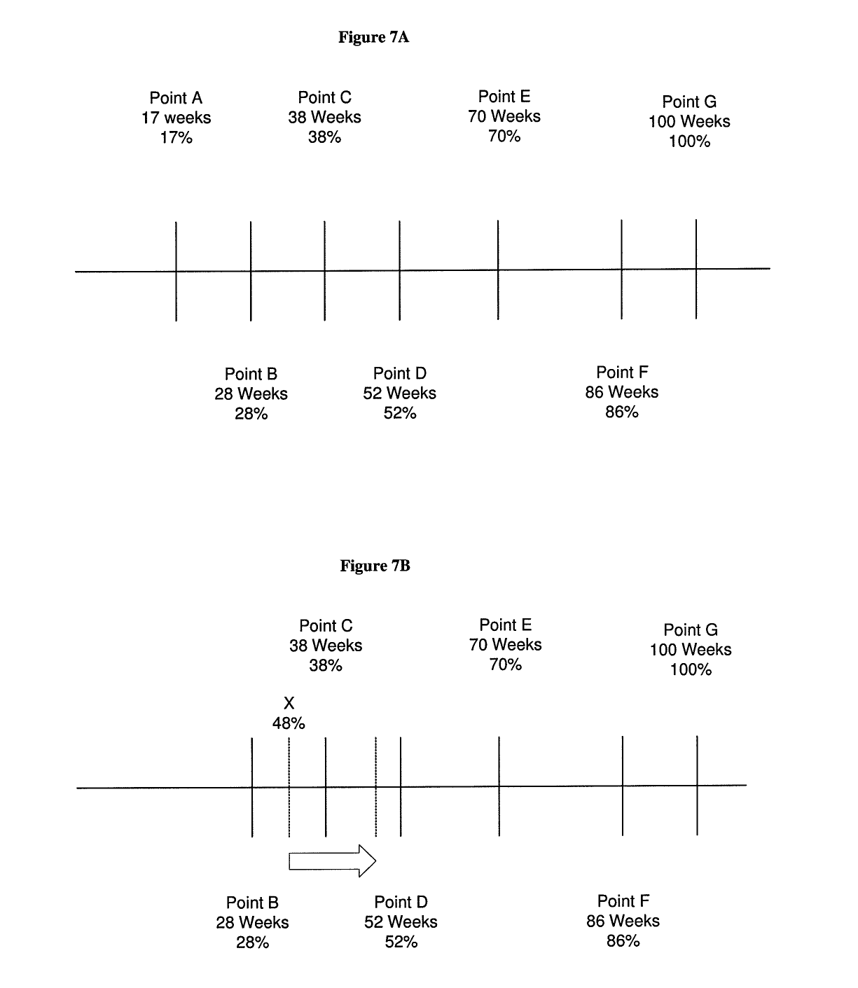

FIGS. 7A and 7B illustrate an electronic timeline, according to an aspect of the present disclosure. In FIG. 7A, an original timeline shows 7 progress markers labeled as points A through G. For ease of understanding, each progress marker corresponds to a percentage of completion that also corresponds to the number of weeks progressed along the timeline. In FIG. 7B, a one-time event occurs and moves progress forward as shown by X. The computer system described herein recognizes the one-time event, and extrapolates between points C and D to determine the location of X and the corresponding values such as percentage of completion and weeks of progress. The extrapolation may be performed using data from the account holder, such as current weight, current progress, how much unscheduled money has been added to an account from the last report, and so on.

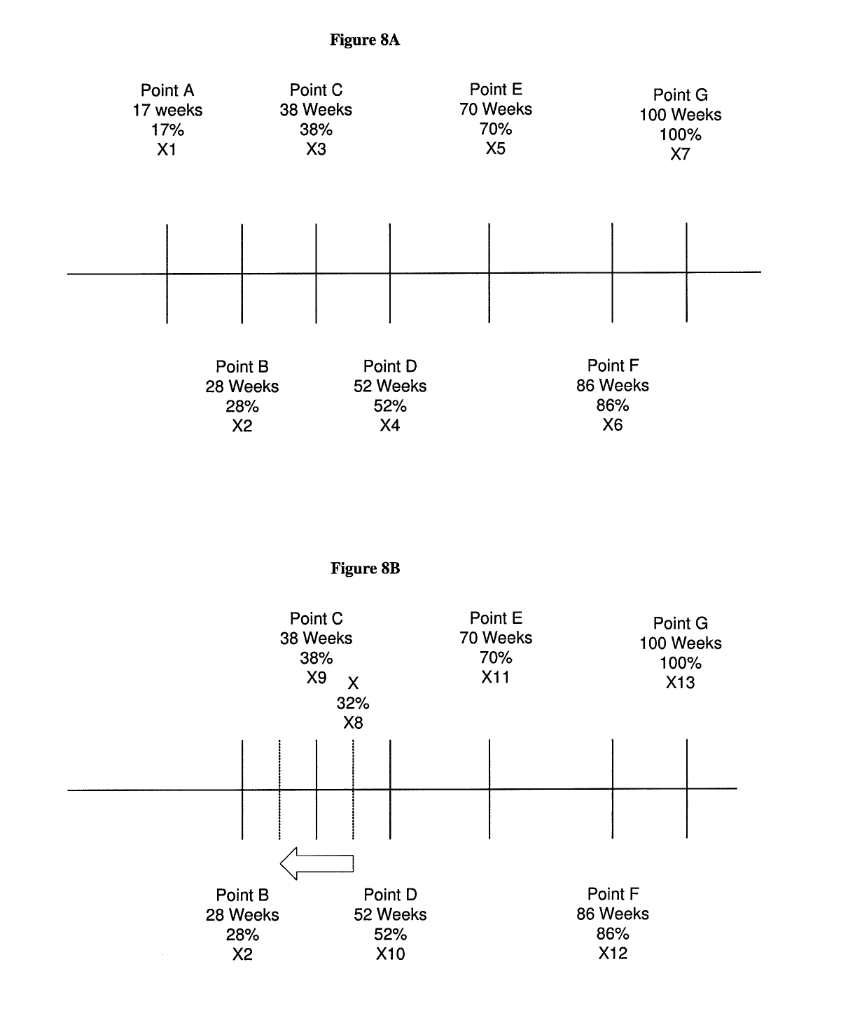

FIGS. 8A and 8B illustrate an electronic timeline, according to an aspect of the present disclosure. FIGS. 8A and 8B show the same changes as FIGS. 6A and 6B, but also show a variable value that changes for every progress marker on the reconstructed timeline due to the backward movement along the timeline. In FIG. 8B, each progress marker forward (i.e., for points C through G) is assigned a new variable value based on the movement backward from the one-time event shown as X8. The variable value for X8 and each subsequent variable value for the reset electronic timeline is calculated using whatever predetermined metrics the account provider uses to assign the variable value.

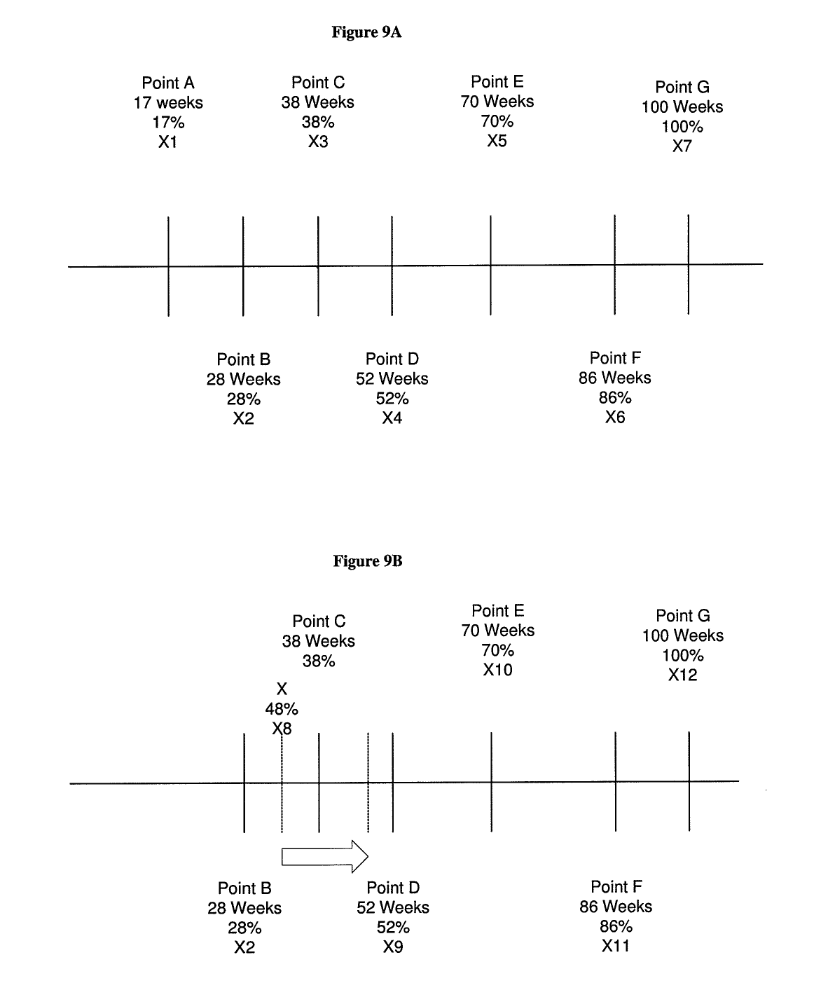

FIGS. 9A and 9B illustrate an electronic timeline, according to an aspect of the present disclosure. FIGS. 9A and 9B show the same changes as FIGS. 7A and 7B, but also show a variable value that that changes for every progress marker on the reconstructed timeline due to the forward movement along the electronic timeline. In FIG. 9B, each progress marker forward (i.e., for points D through G) is assigned a new variable value based on the movement forward from the one-time event shown as X8. The variable value for X8 and each subsequent variable value for the reset electronic timeline is calculated using whatever predetermined metrics the account provider uses to assign the variable value.

The examples herein are merely provided for purposes of enhancing understanding of the present disclosure, and should not be considered as limiting. Those having ordinary skill in the art would readily understand that these examples may be extended and that other examples may be substituted for the ones disclosed.

According to an aspect of the present disclosure, at least one non-transitory tangible computer readable storage medium stores executable instructions for providing timeline reconstruction. The executable instructions, when executed by a tangible computer processor, cause a computer to collect, for a first period, a periodic contribution amount and aggregate the periodic contribution amount collected as an balance of collected periodic amounts from the first period and at least a period immediately previous to the first period. The executable instructions, when executed by a tangible computer processor, also cause a computer to obtain a new periodic multiplier contribution balance for the first period by multiplying the periodic contribution amount for the first period by a variable multiplier that is variable for each period. The executable instructions, when executed by a tangible computer processor, also cause a computer to determine a new cumulative multiplier contribution balance for the first period by adding the new periodic multiplier contribution obtained to a previous cumulative multiplier contribution balance determined for the period immediately previous to the first period.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the Figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of reconstructing an electronic timeline for an account, comprising:
establishing an electronic timeline for an account holder, the electronic timeline including items to be completed for a number of periods;
generating a projected set of variables to apply at each period based on the occurrence or non-occurrence of a predetermined event, and matching each of the projected set of variables with a corresponding item to be completed for a corresponding period and a corresponding mark showing total progress along the timeline for the corresponding period;
over a plurality of periods, confirming that the account is proceeding along the electronic timeline and setting an increasing mark showing total progress for the account for each period based on confirmation of completion of items to be completed and non-occurrence of the predetermined event;
upon receipt of confirmation of completion of a new item for a new period and after confirming the occurrence of the predetermined event, comparing the new period and the mark showing total progress prior to receipt of confirmation of completion of the new item against the account timeline and, identifying the variable to apply for the period by performing a process comprising:
matching the mark showing total progress prior to receipt of confirmation of completion of the new item with two closest marks showing total progress on the electronic timeline; and
calculating an interpolated variable from two variables from the projected set of variables that correspond to the two closest marks showing total progress, and
applying the interpolated variable for the period to generate a new cumulative score showing total progress for the account.

2. The method of claim 1,
wherein the electronic timeline is a two-dimensional map,
wherein the map uses time on a first axis, and matches progressively increasing marks showing total progress for each period of time on the first axis, and
wherein the map uses incoming amounts on a second axis, and matches progressively increasing variables for each incoming amount on the second axis.

3. The method of claim 1,
wherein the new item is received from an intermediary.

4. The method of claim 1,
wherein the predetermined event comprises a deduction in a previous period that reduced the mark showing total progress prior to receipt of the new item.

5. The method of claim 1,
wherein the predetermined event comprises a change in a previous period that increased the mark showing total progress prior to receipt of the new item.

6. The method of claim 1,
wherein the projected set of variables vary at a varying rate over the electronic timeline.

7. The method of claim 6,
wherein the projected set of variables increase at an increasing rate over the electronic timeline.

8. The method of claim 6,
wherein the variable is reduced for the new period based on the occurrence of the predetermined event.

9. A system for reconstruction an electronic timeline for an account, the system comprising:
a memory that stores executable instructions; and
a processor that executes the executable instructions,
wherein, when executed by the processor, the executable instructions cause the system to perform a process comprising:
establishing an electronic timeline for an account holder, the electronic timeline including items to be completed for a number of periods;
generating a projected set of variables to apply at each period based on the occurrence or non-occurrence of a predetermined event, and matching each of the projected set of variables with a corresponding periodic amount for a corresponding period and a corresponding mark showing total progress along the timeline for the corresponding period;
over a plurality of periods, confirming that the account is proceeding along the electronic timeline and setting an increasing mark showing total progress for the account for each period based on confirmation of completion of items to be completed and non-occurrence of the predetermined event;
upon receipt of confirmation of completion of a new item for a new period and after confirming the occurrence of the predetermined event, comparing the new period and the mark showing total progress prior to receipt of confirmation of completion of the new item against the electronic timeline and, identifying the variable to apply for the period using a processor of the system to perform a process comprising:
matching the mark showing total progress prior to receipt of confirmation of completion of the new item with two closest marks showing total progress on the electronic timeline; and
calculating an interpolated variable from two variables from the projected set of variables that correspond to the two closest marks showing total progress, and
applying the interpolated variable for the period to generate a new cumulative score showing total progress for the account.

10. At least one non-transitory tangible computer readable storage medium that stores executable instructions for completing account information, the executable instructions, when executed by a tangible computer processor, causing a computer to perform a process comprising:
establishing an electronic timeline for an account holder, the electronic timeline including items to be completed for a number of periods;
generating a projected set of variables to apply at each period based on the occurrence or non-occurrence of a predetermined event, and matching each of the projected set of variables with a corresponding periodic amount for a corresponding period and a corresponding mark showing total progress along the timeline for the corresponding period;
over a plurality of periods, confirming that the account is proceeding along the electronic timeline and setting an increasing mark showing total progress for the account for each period based on confirmation of completion of items to be completed and non-occurrence of the predetermined event;
upon receipt of confirmation of completion of a new item for a new period and after confirming the occurrence of the predetermined event, comparing the new period and the mark showing total progress prior to receipt of confirmation of completion of the new item against the electronic timeline and, using a processor of a computer that includes the computer readable medium to identify the variable to apply for the period by performing a process comprising:
matching the mark showing total progress prior to receipt of confirmation of completion of the new item with two closest mark showing total progress on the electronic timeline; and
calculating an interpolated variable from two variables from the projected set of variables that correspond to the two closest marks showing total progress, and
applying the interpolated variable for the period to generate a new cumulative score showing total progress for the account.
